(19) United States
(12) Patent Application Publication
(10) Pub. No.: US 2026/0187836 A1
(43) Pub. Date: Jul. 2, 2026

(54) SLOT-LEVEL ROBOTIC PLACEMENT USING ONE DEMONSTRATION VIDEO

(71) Applicant: NVIDIA Corporation, Santa Clara, CA (US)

(72) Inventors: Dandan Shan, Ann Arbor, MI (US); Kirkland Mo, Kirkland, WA (US); Wei Yang, Lake Forest Park, WA (US); Yu-Wei Chao, Redmond, WA (US); Dieter Fox, Seattle, WA (US); Arsalan Mousavian, Seattle, WA (US)

(21) Appl. No.: 19/197,326

(22) Filed: May 2, 2025

Related U.S. Application Data
(60) Provisional application No. 63/741,344, filed on Jan. 2, 2025.

(51) Int. Cl. G06T 7/73; B25J 9/16

(52) U.S. Cl. CPC G06T 7/74; B25J 9/1697; G06T 2207/10016; G06T 2207/10024; G06T 2207/10028; G06T 2207/20081

(57) ABSTRACT

Slot-level object placement by a robot can be implemented through learning from one demonstration video and one image of the object in the robot perspective. A modular system can be used to tackle this problem while alleviating the need for additional teaching video data, by using a slot-level placement detector. The slot-level detector can generate two-dimensional masks to segment slot masks in the placement container and to allow transformations from the demonstration video perspective to a robot perspective. The resulting transformation can be used by the robot to place one or more objects in slots of the placement object.

### CROSS-REFERENCE

This application claims the benefit of U.S. Provisional Application Ser. No. 63/741,344, filed by Dandan Shan, et al., on Jan. 2, 2025, entitled “SLOT-LEVEL ROBOTIC PLACEMENT USING ONE DEMONSTRATION VIDEO,” commonly assigned with this application and incorporated herein by reference in its entirety.

### TECHNICAL FIELD

This application is directed, in general, to teach robotic movement and, more specifically, to using one video with depth information to teach the movement.

### BACKGROUND

Traditional methods of teaching robotic movement may require manual programming with domain expertise and may assume that the object models and slot locations (placement locations) are known beforehand. Learning-based approaches show promise at alleviating the burden of programming. Though collecting robot data through teleoperation remains tedious and inefficient and may be brittle for high-precision tasks due to embodiment gaps. Learning from demonstration videos has recently emerged as a promising approach due to their ease, speed of collection, and potential to capture slot-level details. Previous research has been limited to coarse object level tasks and may require large amounts of teaching data to learn how to parse demonstrations and translate them into robotic policies.

### SUMMARY

In one aspect, a method is disclosed. In one embodiment, the method includes (1) receiving input parameters, wherein the input parameters include a demonstration video of a first perspective of a manipulated object being placed into a slot location where the demonstration video includes depth information, an original image of the manipulated object, and the slot location of a placement object, (2) tracking placement of the manipulated object within the demonstration video, forming a first perspective parameter set, (3) identifying the slot location within the demonstration video using a first frame of the demonstration video and a last frame of the demonstration video after the manipulated object is placed in the slot location thereby by generating a first two-dimensional (2D) placement slot mask of the first frame and the last frame for the first perspective parameter set, (4) re-detecting the manipulated object, the slot location, and non-filled slots of the placement object from a second perspective forming a second perspective parameter set, (5) computing one or more relative poses of the manipulated object to determine an object orientation for the manipulated object from the first perspective and the second perspective, using the first 2D placement slot mask, the first perspective parameter set, and the second perspective parameter set, and (6) determining a set of movements to accomplish a pick-and-place action using the one or more relative poses, the first 2D placement slot mask, the first perspective parameter set, and the second perspective parameter set.

In a second aspect, a system is disclosed. In one embodiment, the system includes (1) a receiver, operational to receive input parameters, wherein the input parameters include a demonstration video from a first perspective showing a placement in a slot location of a manipulated object in a placement object and at least one image of the manipulated object from a second perspective, and (2) one or more processors configured to generate a robotic teaching including a set of movements to accomplish a pick-and-place action by tracking a placement of the manipulated object within the demonstration video, forming a first perspective parameter set, identifying the slot location within the demonstration video using a first frame of the demonstration video and a last frame of the demonstration video after the manipulated object is placed in the slot location thereby by generating a two-dimensional (2D) placement slot mask of the first frame and the last frame for the first perspective parameter set, re-detecting the manipulated object, the slot location, and non-filled slots of the placement object from the second perspective forming a second perspective parameter set, and computing one or more relative poses of the manipulated object to determine an object orientation for the manipulated object from the first perspective and the second perspective, using the 2D placement slot mask, the first perspective parameter set, and the second perspective parameter set.

In a third aspect, non-transitory computer program product having a series of operating instructions stored on a non-transitory computer-readable medium that directs a video processing apparatus when executed thereby to perform operations is disclosed. In one embodiment, the operations include (1) receiving input parameters, wherein the input parameters include a demonstration video of a first perspective of a manipulated object being placed into a slot location where the demonstration video includes depth information, an original image of the manipulated object, and the slot location of a placement object, (2) tracking placement of the manipulated object within the demonstration video, forming a first perspective parameter set, (3) identifying the slot location within the demonstration video using a first frame of the demonstration video and a last frame of the demonstration video after the manipulated object is placed in the slot location thereby by generating a first two-dimensional (2D) placement slot mask of the first frame and the last frame for the first perspective parameter set, (4) re-detecting the manipulated object, the slot location, and non-filled slots of the placement object from a second perspective forming a second perspective parameter set, (5) computing one or more relative poses of the manipulated object to determine an object orientation for the manipulated object from the first perspective and the second perspective, using the first 2D placement slot mask, the first perspective parameter set, and the second perspective parameter set, and (6) determining a set of movements to accomplish a pick-and-place action using the one or more relative poses, the first 2D placement slot mask, the first perspective parameter set, and the second perspective parameter set.

### BRIEF DESCRIPTION

Reference is now made to the following descriptions taken in conjunction with the accompanying drawings, in which:

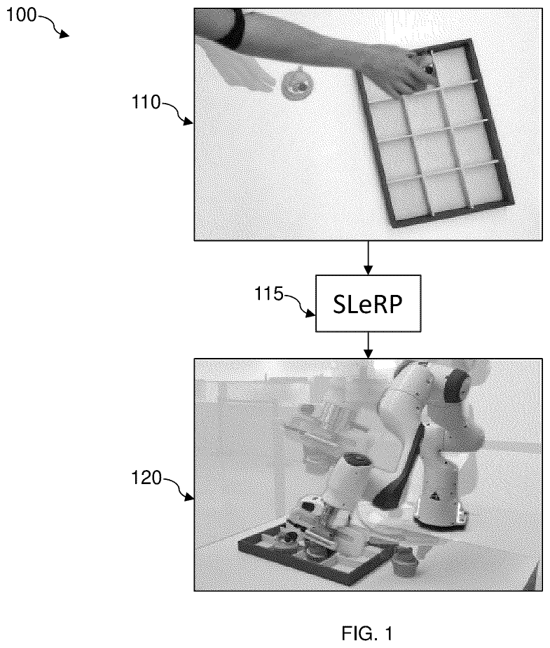

FIG. 1 is an illustration of a diagram of an example process to use one video with depth information to teach a robot;

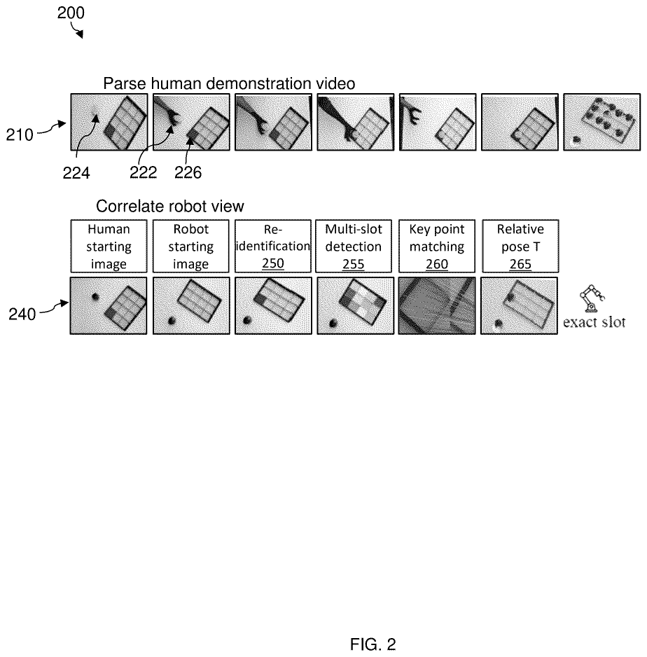

FIG. 2 is an illustration of a diagram of an example process flow showing the disclosed processes;

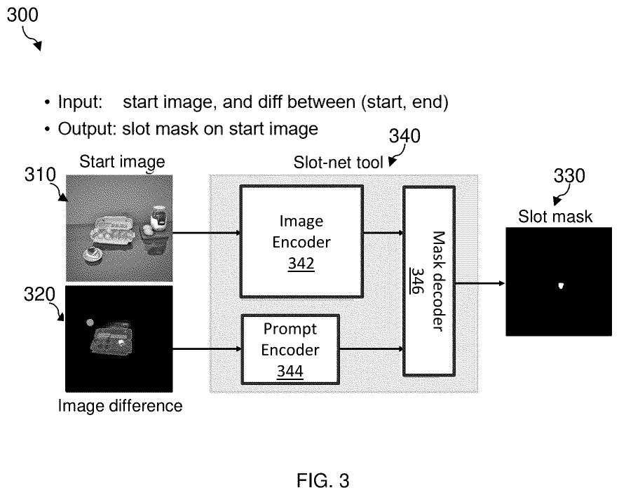

FIG. 3 is an illustration of a diagram of an example slot-net algorithm;

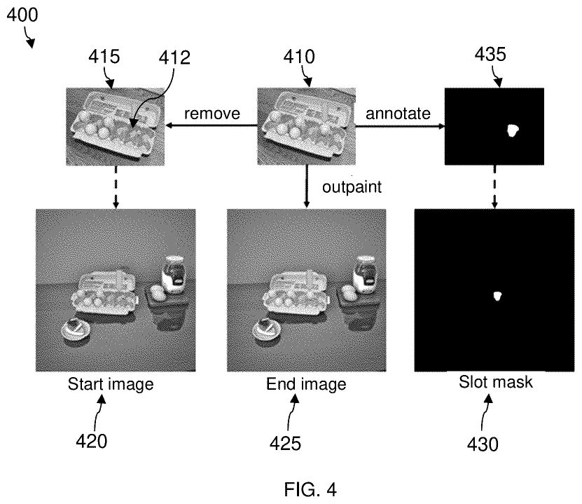

FIG. 4 is an illustration of a diagram of an example process to generate the teaching data for a slot-net model learning;

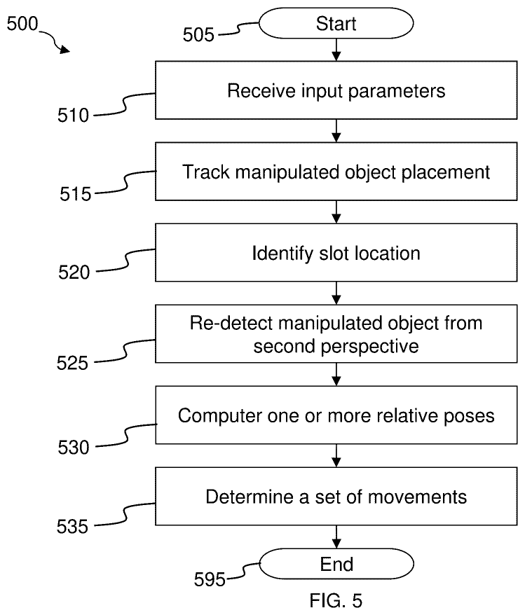

FIG. 5 is an illustration of a flow diagram of an example method to teach a robot using one video with depth information;

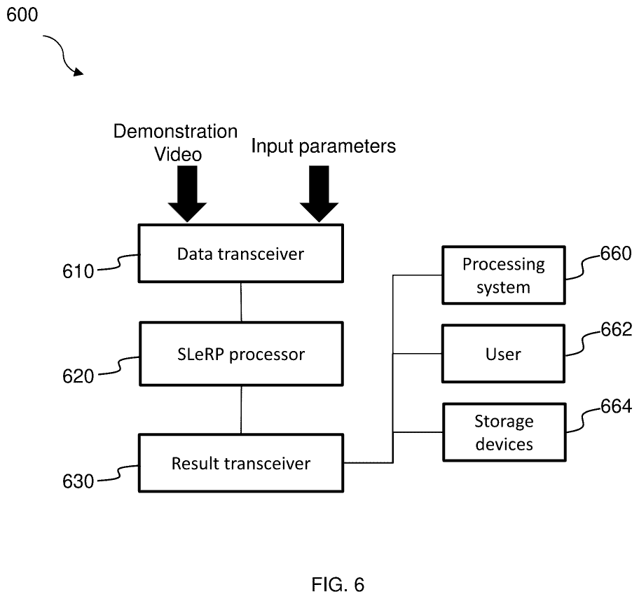

FIG. 6 is an illustration of a block diagram of an example SLeRP system; and

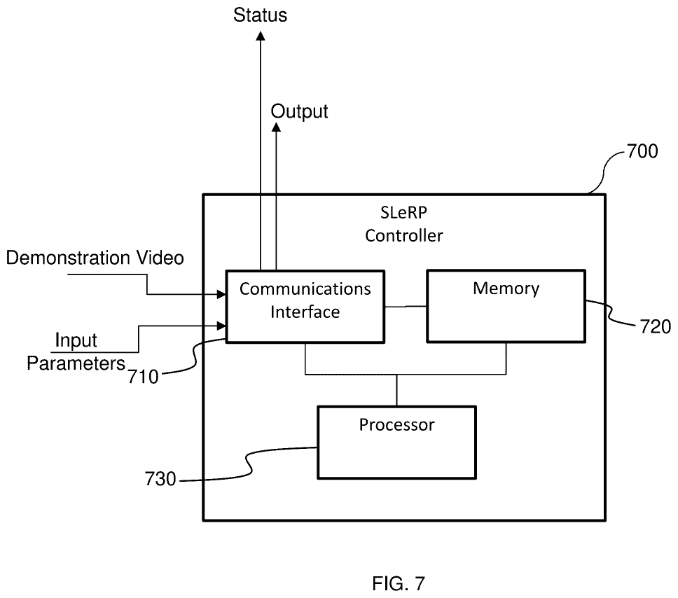

FIG. 7 is an illustration of a block diagram of an example of a SLeRP controller according to the principles of the disclosure.

### DETAILED DESCRIPTION

Humans demonstrate skill in performing fine-grained manipulation tasks with high precision in daily life. From arranging eggs in an egg carton to sorting utensils in an organizer, humans excel at tasks that require identifying and reasoning about which objects to pick and how to place them in confined placement slots. Cognitive and motor development theories suggest that such skills are developed from a young age, based on early experiences like playing with shape sorter toys. Today's robotic and automated systems are not yet as adept as humans at perceiving and performing these fine-grained manipulation tasks.

Slot-level manipulation can be important in various industrial, logistics, and domestic contexts. For example, in industrial settings, machine tending requires components to be precisely placed into machine slots for assembly or processing. In logistics, sorting and packaging tasks, such as organizing parcels in a warehouse or placing products into shipping containers, demand efficient and precise placement to optimize space and minimize damage. In domestic environments, future home assistant robots may need to perform slot-level manipulation tasks like organizing items in cabinets, placing dishes in a dishwasher, and even preparing meals by accurately arranging ingredients in a pan.

Programming robots to perform slot-level placement remains arduous. Traditional methods require manual programming with domain expertise and assume that the object models and slot locations are known beforehand. Learning-based approaches show promise at alleviating the burden of programming. Though, collecting robot data through teleoperation remains tedious and inefficient and can be particularly brittle for high-precision tasks due to embodiment gaps. Learning from demonstration videos has recently emerged as a promising approach due to their ease, speed of collection, and potential to capture slot-level details. Previous research has been limited to coarser object-level tasks and often requires large amounts of teaching data to learn how to parse demonstrations and translate them into robot policies.

This disclosure presents processes to solve the problem of recognizing slot-level object placement from one demonstration video. The demonstration video can be a video with depth information of a human performing an action, a different animal performing an action, a generated video (for example, artificial intelligence (AI) generated or computer-generated video), a robotic video, or other types of demonstration videos. For example, a robot can be programmed to perform one specific action, and the disclosed processes can be used to further teach the robot to generalize the one programmed action to other similar actions. Another example can be to use a video of a chimpanzee performing a repetitive slot placement action and use that to teach a robot intended to mimic the chimpanzee, e.g., a robotic chimpanzee similar to robotic dogs.

Video with depth information can be captured using various types of equipment. For example, equipment can be a depth camera using stereo vision, time of flight data, or infrared light projection to calculate the distance to objects in the scene.

As illustrated in FIG. 1, the process takes two visual inputs: a video (for example, one red-green-blue-depth (RGB-D) video) in which a human demonstrates picking up an object (e.g., an egg) and precisely placing it onto a slot within a placement object (e.g., an egg carton), and an image (for example, one RGB-D image), captured from a potentially different angle and with varied object poses, that represents the setup for the robot to operate in. The video and image can be in various video or image formats now known or later developed. For the output, the object and slot masks can be detected (for example, twelve egg slots) in an input image, including the exact slot demonstrated in the demonstration video and other equivalent slots, as well as a six degrees of freedom (6-DoF) transformation matrix for the placement of the object from its initial position onto each slot.

The disclosure presents a modular approach, SLeRP (Slot-Level Robotic Placement) that does not require expensive video demonstrations during teaching. As shown in FIG. 2, SLeRP can begin by tracking the demonstration hand and the manipulated object, as well as identifying the placement slots in the demonstration video. The robot's analysis first re-detects the corresponding object and empty (e.g., non-filled) slots, due to the potential differences in camera view and object configuration (e.g., a first perspective is the perspective of the demonstration video, and a second perspective is from the robot's perspective of the scene). The second perspective can be from a robot's perspective located proximate (e.g., next to, near enough for the robot to potentially interact with the object, or within a manipulation distance) to the placement object, Then the relative poses of the object and slots between the demonstration and robot views can be computed. The relative poses can be used to determine the action for pick-and-place, which can then be sent to the downstream a robot planner or a robot controller system.

One component of SLeRP can be the detection of placement slots. Image differencing or change detection does not effectively solve this problem. This disclosure presents a new slot-level placement detector, Slot-Net, which takes two image frames from a demonstration video (one before and one after placement) and outputs a 2D mask outlining the placement slot on the images. Unlike common vision tasks, collecting a sizable teaching dataset for this task can be challenging. To address this, a generative AI-based data creation pipeline that expands a teaching set by bootstrapping from a small set of images can be used.

These disclosed processes were tested using a dataset containing 288 real-world videos for quantitative evaluation. The experiments demonstrate that SLeRP can accurately predict placement slots and 6-DoF pick-and-place transformations on real-world tasks. To assess the method, the experiments were benchmarked against existing tools, for example, ORION, for learning object-level pick-and-place from one demonstration video, as well as one slot-level baseline method using vision-language models, such as GPT-4o. Extensive ablation studies further validate several advantageous design choices in the disclosed system.

The disclosures include: (1) Studying a novel task of slot-level object placement by learning from one demonstration video; (2) Designing a modular approach SLeRP and a slot-level placement detector Slot-Net to resolve the problem; and (3) Introducing a new benchmark and baseline methods for systematically evaluating system performance.

The problem of recognizing slot-level object placement from one demonstration video, such as having similar slots as the slots in the same object, as well as the relative poses to the slots, can be resolved. The inputs can be: (1) a video (such as RGB-D video) with n frames X={X₁, X₂, . . . , Xₙ} that shows a demonstration of picking up an object O from the scene and placing it in a slot S within a placement object P; and (2) a video (such as a RGB-D video) robot-view image Y that captures the robot observation in a different scene (e.g., different table and ambient objects), potentially from a different angle and with varied object poses.

The task outputs in the robot's view, can be: (1) an object mask

$${M}_{Y}^{O}$$

segmenting the object O to pick; (2) an exact slot mask

$${M}_{Y}^{S}$$

segmenting the specific slot onto which the demonstration places the object; (3) a list of k other similar slot masks {M^{S}^{ᵢ}}i=1, 2, . . . , k segmenting other non-filled slots on the placement object; or (4) a list of k+1 6-DoF transformation matrices to apply on the object {T₀, T₁, . . . , Tₖ|Tᵢ∈SE(3)} that place the object into each predicted slot (for example, 0 for the exact slot, and 1, . . . , k for the other slots). The 6-DoF transformation matrices can orient the object into a proper orientation relative to the placement object.

SLeRP (such as shown in FIG. 2) can consist of two phases: parsing the input demonstration video X into 2-dimensional (2D) segmentation information about where the hand and object are in throughout the video as well as which exact slot can be filled in the demonstration; and correlating the content in the one robot depth image Y with the parsed demonstration to obtain the exact slot masks, similar slot masks, and required transformations from the robot's perspective.

The input demonstration video can be parsed. Hands and held objects can be identified using hand-object interaction detectors and trackers, producing for each frame Xᵢ an object mask

$${M}_{{X}_{i}}^{O}$$

the demonstration hand comes in contact. The slot mask

$${M}_{{X}_{i}}^{S}$$

can be obtained in the start frame using the Slot-Net model. Once the demonstration video is parsed, information in the robot's coordinate view can be extracted and correlated with the demonstration video. Specifically, masks for the object

$${M}_{Y}^{O}$$

and the corresponding exact slot

$${M}_{Y}^{S}$$

can be identified, and optionally, other similar slots

$${\{ {M}_{Y}^{{S}_{i}} \}}_{i}$$

can be identified. Once the slot masks and correspondences have been identified, the relative transforms between the demonstration and robot views for the object and slots can be computed. By composing these transforms with the object's transform within the demonstration video, the desired 6-DoF transformations {Tᵢ}ᵢ for the object's placement in the robot view can be obtained.

The demonstration video captures one instance of pick-place action performed by a demonstrator. The disclosed processes can extract the pick-object trajectories with visual foundation models and detect the slot with the Slot-Net algorithm.

A hand-object detector can be used to detect frame-wise hands and in-contact objects, enabling the process to locate the picked object in the demonstration video. This system can operate on a per-frame basis, which can result in temporally inconsistent predictions. To smooth the detected bounding boxes a tool, such as MASA's matching algorithm, can be applied to generate a cleaner trajectory for the hand and picked object boxes during the frames in which they are in contact. The segments can be obtained by identifying a confident keyframe (when the hand and object first interact) and using a tool, for example, SAM2, to track through the video, producing per-frame object segmentation

$${M}_{{X}_{i}}^{O} .$$

The Slot-Net process can be a placement slot detection algorithm. The object can be assumed to remain in its initial pose at the beginning of the demonstration video and can be placed onto the slot before the demonstration video ends. Therefore, comparing the start and end frames of the demonstration video can be sufficient to identify the placement slot. Due to the similarity in task nature, SAM's architecture and its segmentation capabilities can be leveraged for slot detection. Slot-Net can be implemented to take the start frame of the pick-place video as input, the image difference between the start and end frame as the prompt, and output the slot segment in the start frame, denoted as

$${M}_{{X}_{i}}^{S} ,$$

for example, as shown in FIG. 3.

Next, using the tracking tool, the slot segments can be obtained throughout the video

$${M}_{{X}_{i}}^{S} .$$

Teaching a large model, like SAM, can require a substantial amount of data. There does not appear to exist current large-scale, high-quality datasets that focus on slot detection. A data generation pipeline can be used to overcome this deficiency, for example, as shown in FIG. 4. The generation pipeline can utilize minimal effort.

In some aspects, a data generation pipeline can be used to generate the start and end image frames of a pick-place action. The processes can expand the available teaching data by starting with a small set of object-centric images of objects with slots.

After parsing the demonstration video, the object and slot information can be known. The next step can be to correlate to the robot-view image by re-identifying the object, exact slot, and other slots. With matched object masks and slot masks between the demonstration video and robot view, the transformation of the object in the robot view can be calculated from its start pose to end pose.

To imitate the action from a demonstration video, the object and slots that enable the same action can be matched. Matching can be performed by taking advantage of a tracking tool tracking ability to match the object and exact slot. Given two frames, one demonstration start frame and one robot-view image, with the object mask in the demonstration start frame as prompts, the tracking tool can re-identify the object in the robot-view image through its tracking ability.

Given the slot mask at the demonstration start frame, the tracking tool can be used to get the corresponding slot mask in the robot view, similar to the object mask above. To generalize to multiple similar slots, with one identified slot mask in the robot view, the feature similarity between the exact slot mask and each tool generated automatic mask in the image can be calculated to find other similar slots in the robot view.

With two corresponding masks in the demonstration view and the robot view, the correspondences can be determined. Since we have the video with depth information data, the correspondences can be lifted to 3-dimensions (3D) using the depth parameter from the video. Equipped with 3D correspondences, the transformation matrix, T, can be calculated between point clouds of two corresponding masks between the demonstration view and the robot view. This can enable the calculation of the transformation between two point clouds, which can be used to calculate the relative pose between the start and end object poses in the robot view.

For each object in the robot view, the object's transformation can be calculated from its start location to the slot. The demonstration start and end frames can be used as a bridge where the object can be transformed in the robot view to the demonstration start frame, from the demonstration start frame to the demonstration end frame and use the slot transformation to transform back to the robot view as the object end location should be.

The transformation from the robot view to the demonstration start frame can be calculated as

$${T}_{Y \to {X}_{1}}^{O}$$

of the object from its start location in the robot view to the demonstration start frame. Within the demonstration video from start to end frames, the calculation can be

$${T}_{{X}_{1} \to {X}_{n}}^{O}$$

of the object from start to end location in the demonstration video. From the demonstration end frame to the robot view, the calculation can be

$${T}_{{X}_{n} \to Y}^{{S}_{i}}$$

of the slot from the demonstration end frame to the robot view. By chaining the transformations, the object in the second perspective, e.g., the robot's viewpoint, can be tracked to its slot location and represented as

$${T}_{i} = {T}_{{X}_{n} \to Y}^{{S}_{i}} {T}_{{X}_{1} \to {X}_{n}}^{O} {T}_{Y \to {X}_{1}}^{O} .$$

Turning now to the figures, FIG. 1 is an illustration of a diagram of an example process 100 to use one video with depth information to teach a robot. Process 100 takes as input a demonstration video showing an object being placed in a slot, along with a robot view image 110 that can feature varied backgrounds, camera angles, and object poses. The analysis and logic can be processed through a processor unit 115. The output can include 2D masks of the object and slot in a robot view 120, masks for similar non-filled slots, and a 6-DoF transformation matrix for each detected slot to guide the robot in positioning the object accurately.

FIG. 2 is an illustration of a diagram of an example process flow 200 showing the disclosed processes. Process flow 200 has a top row 210 showing the parsing of the demonstration video by identifying a hand 222, an object 224, and a slot 226 throughout the sequence. Process flow 200 has a bottom row 240 showing the correlating slot information between the demonstration video and the robot view through a re-identification 250 using a tool, such as SAM2, with optional multi-slot detection enabled using a second tool 255, such as DINOv2 using feature similarity. A third tool 260, such as MASt3R, can be used for key point matching to calculate relative poses 265 between slots.

FIG. 3 is an illustration of a diagram of an example slot-net algorithm 300. Process 300 can use a tool, such as SAM, to predict the placement of the object using a slot mask 330 with a plain image difference 320 between a start image 310 and an end image as a prompt. The slot-net architecture shows a first image and a last image being used to generate slot mask 330. Slot-net algorithm 300 can be implemented by a slot-net tool 340. Slot-net tool 340 can include various components, such as an image encoder 342, a prompt encoder 344, and a mask decoder 346. These components can be utilized to generate the predicted slot mask.

FIG. 4 is an illustration of a diagram of an example process 400 to generate the teaching data for slot-net model learning. At a high level, the algorithm starts with an object-centric image 410 of an object 412 with slots. Object 412 can be removed (e.g., inpainting) from the slot for a start frame 415. Then, to place the object in context, different backgrounds can be outpainted to generate the new start scene and the new end scene. This pipeline, with various controls for object removal (e.g., inpainting) and outpainting, can enable the creation of many variants from one object-centric image.

The object-centric images are collected to be used to generate (start, end) pairs as training data for Slot-Net learning. In this example, the egg carton can be partially filled, so that masking would have to identify slots that are filled and slots that are non-filled in the egg carton. Object-centric images of items with slots can be collected by capturing them in everyday environments. These images can serve as the end object crops and can be used to generate corresponding start images by removing objects and creating a start image 420 (e.g., a first frame) and an end image 425 (e.g., a last frame) pair for a pick-and-place action. During data collection, participants partially fill the slots. This ensures that slots are not entirely non-filled, making object removal feasible, while avoiding filled slots, which can complicate inpainting during object removal.

The captured image can serve as an object-centric end image. To create the appearance of object-centric start images when objects are not in the slot, a tool, such as SDXL, can be used for inpainting modeling to remove the pick-object from the slots. In some aspects, in a second round of object removal on failures from the tool, a tool, such as Cleanup.pictures, can be used to achieve further removal results.

After obtaining the (start, end) object-centric images, the process can annotate a slot mask 430 by comparing each pair using a tool, such as TORAS. Annotation of masks 435 can be completed before augmentation, at which point the masks can be transformed onto the canvas to provide labels on a large amount of data.

For each object-centric slot object, A bigger scene can be created by first sampling random locations, for example, on a 1024×1024 canvas though other sizes can be used, and then outpainting with different generated prompts. In some aspects, a short category name can be given such as “bread in toaster”. A tool, such as Llama, can then be used to enrich the text prompt by adding descriptions of the environment. The start object crop images and slot masks follow the same transformation to create the outpainted (start, end) image pairs and the corresponding ground-truth slot masks.

FIG. 5 is an illustration of a flow diagram of an example method 500 to teach a robot using one video with depth information. Method 500 can be performed on a computing system, for example, SLeRP system 600 of FIG. 6 or SLeRP controller 700 of FIG. 7. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 500 can be encapsulated in software code or hardware, for example, an application, code library, code module, dynamic link library, module, function, RAM, ROM module, and other software and hardware implementations. The software can be stored in a file, database, or other computing system storage mechanism. Method 500 can be partially implemented in software and partially in hardware. Method 500 can perform the steps for the described processes, for example, identifying the movement and placement of an object from one demonstration video and transforming the identification into a generalized inference for robotic replication of the action performed.

Method 500 starts at a step 505 and proceeds to a step 510. In step 510 input parameters can be received. The input parameters can include a demonstration video (for example, one RGB-D video) in which the video demonstrates picking up an object (e.g., an egg) and precisely placing it onto a slot within a placement object (e.g., an egg carton), and an original image (for example, one RGB-D image), captured from a potentially different angle and with varied object poses, that represents the setup for the robot to operate in. The input parameters can include operational parameters, for example, a set of tools to use to perform part of the processes.

In a step 515, the placement of the manipulated object can be tracked within the demonstration video, forming a first perspective parameter set. In a step 520, the slot location can be identified within the demonstration video using a first object-centric image taken from a first frame of the demonstration video (e.g., a first frame) and a second object-centric image taken from a second frame (e.g., from a last frame) of the demonstration video after the manipulated object can be placed in the available slot location thereby by generating a 2D placement slot mask of the first object-centric image and the second object-centric image for the first perspective parameter set.

In a step 525, the manipulated object, the slot location, and non-filled slots of the placement object can be re-detected from a second perspective forming a second perspective parameter set. The second perspective can be from the perspective of an automated tool, such as a robot arm. In a step 530, one or more relative poses of the manipulated object can be computed to determine an object orientation for the manipulated object from the first perspective and the second perspective, using the 2D placement slot mask, the first perspective parameter set, and the second perspective parameter set.

In a step 535, a set of movements to accomplish a pick-and-place action can be determined using the one or more relative poses, the 2D, placement slot mask, the first perspective parameter set, and the second perspective parameter set. In some aspects, the set of movements can be communicated to a robot and used as directions for subsequent movement of the robot. In some aspects, the set of movements can be communicated to a robot controller system or a robot planner. In some aspects, the set of movements can be communicated to a data store. In some aspects, the set of movements can be communicated to another system and used as input parameters, for example, to be used with other fine-tuned robotic teaching to train more complex movements of the robot. In some aspects, the fine-tuned robotic teaching can be used by a robot to perform a repetitive task over a different slot location of the placement object. In some aspects, the set of movements and the input parameters can be communicated to a machine learning system to train the system enabling faster computations in subsequent executions of the disclosed processes. In some aspects, the set of movements (e.g., the robotic teaching) can be extrapolated and used for a different placement object. Method 500 ends at a step 595.

FIG. 6 is an illustration of a block diagram of an example SLeRP system 600. SLeRP system 600 can be implemented in one or more computing systems or one or more processors. In some aspects, SLeRP system 600 can be implemented using a SLeRP controller such as SLeRP controller 700 of FIG. 7. SLeRP system 600 can implement one or more aspects of this disclosure, such as method 500 of FIG. 5.

SLeRP system 600, or a portion thereof, can be implemented as an application, a code library, a dynamic link library, a function, a module, a header file, other software implementations, or combinations thereof. In some aspects, SLeRP system 600 can be implemented in hardware, such as a ROM, a graphics processing unit, or other hardware implementation. In some aspects, SLeRP system 600 can be implemented partially as a software application and partially as a hardware implementation. SLeRP system 600 is a functional view of the disclosed processes, and an implementation can combine or separate the functions in one or more software or hardware systems.

SLeRP system 600 includes a data transceiver 610, a SLeRP processor 620, and a result transceiver 630. The output, e.g., the fine-tuned robotic teaching (generalized inferences for robotic movement replicating a demonstration video), can be communicated to a data receiver, such as one or more of a processing system 660 (one or more combinations of processors or processing cores), one or more users 662, or one or more storage devices 664. The output can be used to store fine-tuned robotic teaching.

In some aspects, the results of the SLeRP processor, such as those communicated to one or more processing systems 660, one or more storage devices 664, or one or more users 662, can be used as input into another process or system. The robotic teaching can be used for further processing, such as for input into other robotic teaching, for validation of other system processes, or real-world applications, such as industrial or domestic uses.

Data transceiver 610 can receive the input parameters. The input parameters can be one or more demonstration videos, one or more images varying the object poses, or operational parameters such as the set of tools to utilize for each step of the method, and other operational parameters. In some aspects, data transceiver 610 can be part of SLeRP processor 620.

Result transceiver 630 (e.g., a transmitter) can communicate one or more outputs, to one or more data receivers, such as processing systems 660, one or more users 662, storage devices 664, or other related systems, whether proximate result transceiver 630 or distant from result transceiver 630. Data transceiver 610, SLeRP processor 620, and result transceiver 630 can be, or can include, conventional interfaces configured for transmitting and receiving data. Data transceiver 610, SLeRP processor 620, or result transceiver 630 can be implemented as software components, for example, a virtual processor environment, as hardware, for example, circuits of an integrated circuit, or combinations of software and hardware components and functionality. The functionality described for these components remains intact regardless of how the functionality is implemented.

SLeRP processor 620 (e.g., one or more processors such as processor 730 of FIG. 7) can implement the analysis and algorithms as described herein utilizing the input parameters. SLeRP processor 620 can be one or more of a multicore processor, a multiprocessor system, or a streaming multiprocessor. SLeRP processor 620 can be implemented by a central processor unit (CPU), a graphics processor unit (GPU), or other types of processors. SLeRP processor 620 can be a non-transitory computer program product having a series of operating instructions stored on a non-transitory computer-readable medium that directs a video processing apparatus when executed thereby to perform operations as disclosed herein.

A memory or data storage system of SLeRP processor 620 (such as a core cache, L1 cache, L2 cache, or other memory systems) can be configured to store the processes and algorithms for directing the operation of SLeRP processor 620. SLeRP processor 620 can include a processor that can be configured to operate according to the analysis operations and algorithms disclosed herein, and an interface to communicate (transmit and receive) data.

FIG. 7 is an illustration of a block diagram of an example of a SLeRP controller 700 according to the principles of the disclosure. SLeRP controller 700 can be stored on one computer or multiple computers. The various components of SLeRP controller 700 can communicate via wireless or wired conventional connections. A portion or a whole of SLeRP controller 700 can be located at one or more locations. In some aspects, SLeRP controller 700 can be part of another system (e.g., processor, core, server, or other systems), and can be integrated with one device, such as a part of a processing system. SLeRP controller 700 represents a demonstration of the functionality employed for the disclosure, and implementations can use a variety of devices, for example, circuits of a processor, dedicated processors, virtual systems, servers, other computing or processing systems, be in software or hardware, or various combinations thereof.

SLeRP controller 700 can be configured to perform the various functions disclosed herein including receiving input parameters and generating results from the execution of the methods and processes described herein, such as teaching a robot for slot placement of an object to generate fine-tuned robotic teaching. SLeRP controller 700 includes a communications interface 710, a memory 720, and a processor 730.

Communications interface 710 can be configured to transmit and receive data. For example, communications interface 710 can receive the input parameters. Communications interface 710 can transmit the output or interim outputs. In some aspects, communications interface 710 can transmit a status, such as a success or failure indicator of SLeRP controller 700 regarding receiving the various inputs, transmitting the generated outputs, or producing the results.

In some aspects, processor 730 can perform the operations as described by SLeRP processor 620. Communications interface 710 can communicate via communication systems used in the industry. For example, wireless or wired protocols can be used. Communication interface 710 can perform the operations as described for data transceiver 610 and result transceiver 630 of FIG. 6.

Memory 720 can be configured to store a series of operating instructions that direct the operation of processor 730 when initiated, including supporting code representing the algorithm for teaching a robot with fine-tuned robotic teaching. Memory 720 can be a non-transitory computer-readable medium. Multiple types of memory can be used for the data storage systems and memory 720 can be distributed.

Processor 730 can be one or more processors. Processor 730 can be a combination of processor types, such as a CPU, a GPU, a single instruction multiple data (SIMD) processor, or other processor types. Processor 730 can be configured to produce the output, one or more interim outputs, and statuses utilizing the received inputs. Processor 730 can determine the output using parallel processing. Processor 730 can be an integrated circuit. In some aspects, processor 730, communications interface 710, memory 720, or various combinations thereof, can be an integrated circuit. Processor 730 can be configured to direct the operation of SLeRP controller 700. Processor 730 includes the logic to communicate with communications interface 710 and memory 720, and perform the functions described herein. Processor 730 can be capable of performing or directing the operations as described by SLeRP processor 620 of FIG. 6.

For example, in some aspects, SLeRP system 600 or SLeRP controller 700 can perform an image retrieval function and can be part of a system, process, or application, or can be accessed remotely, such as a code library, remote function, or remote process. In some aspects, SLeRP system 600 or SLeRP controller 700 can be part of another system that receives. For example, in some aspects, SLeRP system 600 or SLeRP controller 700 can be part of a machine learning system, an AI generative tool, or can be in a data center, a cloud system, an edge system, a corporate system, or other type of system or location. In some aspects, the demonstration videos can be received from a data store, such as a database or a server. In some aspects, SLeRP system 600 or SLeRP controller 700 can be part of a machine learning system, where the SLeRP processor can be part of the machine learning processes. In some aspects, SLeRP system 600 or SLeRP controller 700 can implement a non-transitory computer program product having a series of operating instructions stored on a non-transitory computer-readable medium that directs a data processing apparatus when executed thereby to perform operations, the operations comprising the steps described herein for this disclosure, such as method 500 of FIG. 5.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks.

Portions of disclosed examples or embodiments can relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
receiving input parameters, wherein the input parameters include a demonstration video of a first perspective of a manipulated object being placed into a slot location where the demonstration video includes depth information, an original image of the manipulated object, and the slot location of a placement object;
tracking placement of the manipulated object within the demonstration video, forming a first perspective parameter set;
identifying the slot location within the demonstration video using a first frame of the demonstration video and a last frame of the demonstration video after the manipulated object is placed in the slot location thereby by generating a first two-dimensional (2D) placement slot mask of the first frame and the last frame for the first perspective parameter set;
re-detecting the manipulated object, the slot location, and non-filled slots of the placement object from a second perspective forming a second perspective parameter set;
computing one or more relative poses of the manipulated object to determine an object orientation for the manipulated object from the first perspective and the second perspective, using the first 2D placement slot mask, the first perspective parameter set, and the second perspective parameter set; and
determining a set of movements to accomplish a pick-and-place action using the one or more relative poses, the first 2D placement slot mask, the first perspective parameter set, and the second perspective parameter set.

2. The method as recited in claim 1, wherein the identifying the slot location further comprises:
generating the first frame by removing the manipulated object from the placement object of an object-centric image with slots; and
outpainting one or more backgrounds for the first frame and the last frame to generate at least one new start scene and one new end scene containing the manipulated object.

3. The method as recited in claim 2, wherein the generating the first frame uses a received collection of images representing at least one orientation of the manipulated object, and the collection of images are generated by the removing of the manipulated object.

4. The method as recited in claim 1, wherein the identifying the slot location further comprises:
calculating one or more additional 2D placement slot masks that are different from the slot location for the placement object.

5. The method as recited in claim 1, wherein the second perspective parameter set includes a second 2D placement slot mask, and the computing the one or more relative poses further comprises:
generating a 3D correspondence using the first perspective parameter set and the second perspective parameter set; and
calculating the one or more relative poses, using the 3D correspondence, through a transformation matrix calculated between point clouds of the first 2D placement slot mask and the second 2D placement slot mask.

6. The method as recited in claim 1, wherein the computing one or relative poses further comprises:
calculating a transformation of the manipulated object from a start location of the manipulated object to the slot location by first transforming the manipulated object from the second perspective to the start location in the first perspective, second transforming the manipulated object from start location to the slot location in the first perspective, and third transforming the manipulated object back to the second perspective following a slot transformation.

7. The method as recited in claim 1, wherein the set of movements are communicated to a robot and used as directions for subsequent movements of the robot.

8. The method as recited in claim 1, wherein the set of movements are used by a robot planner or a robot controller system.

9. The method as recited in claim 1, wherein the set of movements are used by another system as an input for machine learning or robot learning.

10. The method as recited in claim 1, wherein the set of movements includes directions to a robot to place the manipulated object into an available slot location of the placement object, where the manipulated object is moved within six degrees of freedom (6-DoF) transformation to have a proper orientation in the placement object.

11. The method as recited in claim 1, wherein the demonstration video is a red-green-blue-depth (RGB-D) video.

12. The method as recited in claim 1, wherein the original image is captured from a different angle compared to the demonstration video.

13. The method as recited in claim 1, wherein the demonstration video shows the manipulated object in a first pose, and the last frame shows the placement object in a second pose that is different from the first pose.

14. A system, comprising:
a receiver, operational to receive input parameters, wherein the input parameters include a demonstration video from a first perspective showing a placement in a slot location of a manipulated object in a placement object and at least one image of the manipulated object from a second perspective; and
one or more processors configured to generate a robotic teaching including a set of movements to accomplish a pick-and-place action by tracking a placement of the manipulated object within the demonstration video, forming a first perspective parameter set, identifying the slot location within the demonstration video using a first frame of the demonstration video and a last frame of the demonstration video after the manipulated object is placed in the slot location thereby by generating a two-dimensional (2D) placement slot mask of the first frame and the last frame for the first perspective parameter set, re-detecting the manipulated object, the slot location, and non-filled slots of the placement object from the second perspective forming a second perspective parameter set, and computing one or more relative poses of the manipulated object to determine an object orientation for the manipulated object from the first perspective and the second perspective, using the 2D placement slot mask, the first perspective parameter set, and the second perspective parameter set.

15. The system as recited in claim 14, wherein the one or more processors are part of or executing on a central processor unit (CPU) or a graphics processor unit (GPU).

16. The system as recited in claim 14, further comprising:
a transmitter, operational to communicate the robotic teaching to a robot controller system, wherein the robotic teaching is used to perform a placement task of the manipulated object in a different slot location.

17. The system as recited in claim 14, wherein the demonstration video captures depth information.

18. The system as recited in claim 14, wherein the robotic teaching is used by a robot to perform a repetitive task over a different slot location of the placement object.

19. The system as recited in claim 14, wherein the second perspective is from a robot located within a manipulation distance of the placement object.

20. The system as recited in claim 14, wherein the one or more processors utilize a machine learning system to compute the one or more relative poses and to determine the set of movements.

21. The system as recited in claim 14, wherein the set of movements are extrapolated and used for a different placement object.

22. The system as recited in claim 14, wherein the one or more processors is a SLeRP processor.

23. A non-transitory computer program product having a series of operating instructions stored on a non-transitory computer-readable medium that directs a video processing apparatus when executed thereby to perform operations, the operations comprising:
receiving input parameters, wherein the input parameters include a demonstration video of a first perspective of a manipulated object being placed into a slot location where the demonstration video includes depth information, an original image of the manipulated object, and the slot location of a placement object;
tracking placement of the manipulated object within the demonstration video, forming a first perspective parameter set;
identifying the slot location within the demonstration video using a first frame of the demonstration video and a last frame of the demonstration video after the manipulated object is placed in the slot location thereby by generating a first two-dimensional (2D) placement slot mask of the first frame and the last frame for the first perspective parameter set;
re-detecting the manipulated object, the slot location, and non-filled slots of the placement object from a second perspective forming a second perspective parameter set;
computing one or more relative poses of the manipulated object to determine an object orientation for the manipulated object from the first perspective and the second perspective, using the first 2D placement slot mask, the first perspective parameter set, and the second perspective parameter set; and
determining a set of movements to accomplish a pick-and-place action using the one or more relative poses, the first 2D placement slot mask, the first perspective parameter set, and the second perspective parameter set.

24. The non-transitory computer program product recited in claim 23, wherein the determining the set of movements includes, from the second perspective, an object mask segmenting the manipulated object to move.

25. The non-transitory computer program product recited in claim 23, wherein the determining the set of movements includes, from the second perspective, a list of slot masks segmenting non-filled slots on the placement object.

26. The non-transitory computer program product recited in claim 23, wherein the determining the set of movements includes, from the second perspective, a list of six degrees of freedom (6-DoF) transformation matrices to apply on the manipulated object that place the manipulated object into each predicted slot.
